(19) United States
(12) Patent Application Publication
(10) Pub. No.: US 2026/0170988 A1
(43) Pub. Date: Jun. 18, 2026

(54) DISPLAY DEVICE AND DRIVING METHOD THEREOF

(71) Applicant: AUO Corporation, Hsinchu City (TW)

(72) Inventors: Heng Yi Tseng, Hsinchu City (TW); Yi-Han Tseng, Hsinchu City (TW); Yi-Jyun Ke, Hsinchu City (TW); Jen-Chieh Hsieh, Hsinchu City (TW); Ming-Chun Li, Hsinchu City (TW)

(73) Assignee: AUO Corporation, Hsinchu City (TW)

(21) Appl. No.: 19/181,335

(22) Filed: Apr. 17, 2025

(30) Foreign Application Priority Data
Dec. 18, 2024 (TW) 113149376

(51) Int. Cl. G09G 3/20; G09G 3/36

(52) U.S. Cl. CPC G09G 3/2018; G09G 3/3614; G09G 3/3648; G09G 3/3677; G09G 3/3688; G09G 2310/08; G09G 2320/066

(57) ABSTRACT

Provided are a display device and a driving method thereof. In the display device, a display panel has multiple pixels. A scan driver provides multiple scan signals to the multiple pixels. During a scan period, the scan driver scans a scanned pixel according to the scan signals, and a source driver provides a source driver signal to the scanned pixel according to display grayscale level of the scanned pixel. The source driver sets a voltage peak value of the source driver signal according to display grayscale level of the scanned pixel. Display grayscale level of the scanned pixel is negatively correlated with the voltage peak value of the source driver signal. Alternatively, the source driver sets a duration of the source driver signal according to display grayscale level of the scanned pixel. Display grayscale level of the scanned pixel is negatively correlated with the duration of the source driver signal.

### CROSS-REFERENCE TO RELATED APPLICATION

This application claims the priority benefit of Taiwan application serial no. 113149376, filed on Dec. 18, 2024. The entirety of the above-mentioned patent application is hereby incorporated by reference herein and made a part of this specification.

### BACKGROUND

### Technical Field

The disclosure relates to a driving technology, and particularly relates to a display device and a driving method thereof.

### Related Art

In a conventional cholesteric liquid crystal display (ChLCD), the cholesteric liquid crystal may typically include a planar state, a focal conic state, and a homeotropic state. Generally, the conventional cholesteric liquid crystal display typically presents a bright state of display state using the planar state, and presents a dark state of display state using the focal conic state.

However, since the focal conic state of the cholesteric liquid crystal is not a completely transparent state, but rather a scattering state with diffusion, and under the driving method of the focal conic state, the display device has backscattering when displaying the dark state of display state, thereby affecting the contrast of the display image.

In view of above, how to effectively improve the contrast of the display image of the cholesteric liquid crystal display, in order to enhance the display quality of the display image, will be an important issue for persons skilled in the art.

### SUMMARY

The disclosure provides a display device and a driving method thereof, which can effectively improve the contrast of the display image, thereby enhancing the display quality of the display device.

The display device of the disclosure includes a display panel, a scan driver, and a source driver. The display panel has multiple pixels. The scan driver is coupled to the display panel, providing multiple scan signals to the pixels. The source driver is coupled to the display panel. In an embodiment, during a scan period of a display time interval, the scan driver scans at least one scanned pixel among the pixels according to the scan signals, and the source driver provides at least one source driver signal to the at least one scanned pixel according to a display grayscale level of the at least one scanned pixel. In an embodiment, the source driver sets a voltage peak value of the source driver signal according to the display grayscale level of the at least one scanned pixel, and the display grayscale level of the at least one scanned pixel is negatively correlated with the voltage peak value of the source driver signal. Alternatively, the source driver sets a duration of the source driver signal according to the display grayscale level of the at least one scanned pixel, and the display grayscale level of the at least one scanned pixel is negatively correlated with the duration of the source driver signal.

The driving method of the display device of the disclosure includes the following. A display panel having multiple pixels is provided. A scan driver is provided, so that the scan driver provides multiple scan signals to the pixels, and that the scan driver scans at least one scanned pixel among the pixels according to the scan signals during a scan period of a display time interval. A source driver is provided, so that the source driver provides at least one source driver signal to the at least one scanned pixel according to a display grayscale level of the at least one scanned pixel during the scan period. Also, the source driver is caused to set a voltage peak value of the source driver signal according to the display grayscale level of the at least one scanned pixel, and the display grayscale level of the at least one scanned pixel is negatively correlated with the voltage peak value of the source driver signal. Alternatively, the source driver is caused to set a duration of the source driver signal according to the display grayscale level of the at least one scanned pixel, and the display grayscale level of the at least one scanned pixel is negatively correlated with the duration of the source driver signal.

Based on the above, the display device and the driving method thereof according to various embodiments of the disclosure may, through the source driver using PAM or PWM driving methods, enable the liquid crystal in the pixels of the display panel to present a dark state display state with a homeotropic state according to a relatively large pixel voltage difference. In this way, compared with the related cholesteric liquid crystal display device, the display device of the disclosure is not affected by backscattering in the dark state display performance, thereby enhancing the contrast of the display panel and improving the display quality of the display image.

### BRIEF DESCRIPTION OF THE DRAWINGS

FIG. 1 is a schematic diagram of a display device according to an embodiment of the disclosure.

FIG. 2 is a timing diagram of the display device in FIG. 1 under a first driving method according to the disclosure.

FIG. 3 is a waveform schematic diagram of a pixel voltage difference of each pixel of the embodiment in FIG. 1 under the first driving method according to the disclosure.

FIG. 4 is a timing diagram of the display device in FIG. 1 under a second driving method according to the disclosure.

FIG. 5 is a waveform schematic diagram of the pixel voltage difference of each pixel of the embodiment in FIG. 1 under the second driving method according to the disclosure.

FIG. 6 is a flowchart of a driving method of a display device according to an embodiment of the disclosure.

FIG. 7 is a flowchart of the driving method of the display device according to another embodiment of the disclosure.

### DESCRIPTION OF THE EMBODIMENTS

In the entire specification (including the claims) of the disclosure, the term “coupled (or connected)” may refer to any direct or indirect connection means. For example, if it is described in the text that a first device is coupled (or connected) to a second device, it should be interpreted that the first device may be directly connected to the second device, or the first device may be indirectly connected to the second device through other devices or some connection means. In addition, wherever possible, the same reference numerals in the drawings and embodiments represent the same or similar parts for elements/components/steps. The elements/components/steps using the same reference numerals or the same terms in different embodiments may cross-reference related descriptions.

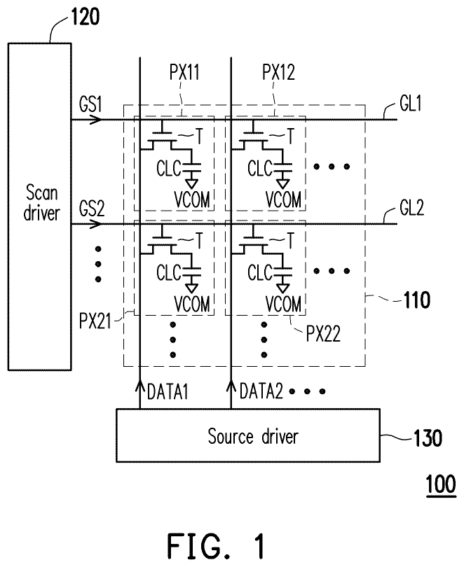

FIG. 1 is a schematic diagram of a display device 100 according to an embodiment of the disclosure. Referring to FIG. 1, the display device 100 includes a display panel 110, a scan driver 120, and a source driver 130. In this embodiment, the display panel 110 includes multiple pixels. For the convenience of explanation and clarity of the drawing, FIG. 1 uses pixels PX11, PX12, PX21, and PX22 as examples for explanation. The number of pixels, source lines, and scan lines shown in FIG. 1 may be determined according to the design requirements of the display panel 110, and the disclosure is not limited to the number of pixels, source lines, and scan lines illustrated in FIG. 1.

For example, the pixels PX11, PX12, PX21, and PX22 in the display panel 110 may be arranged in a matrix, and disposed at the intersections of multiple source lines DL1 to DL2 and multiple scan lines GL1 to GL2.

Regarding the circuit configuration in each of the pixels PX11, PX12, PX21, and PX22, the pixel PX11 is used as an example for explanation, and the circuit configurations in the remaining pixels PX12, PX21, and PX22 may be analogized accordingly. For example, the pixel PX11 may include a transistor T and a liquid crystal capacitor CLC, in which the control terminal (for example, the gate terminal) of the transistor T is coupled to the scan line GL1, the first terminal (for example, the source terminal) of the transistor T is coupled to the first terminal of the liquid crystal capacitor CLC, and the second terminal (for example, the drain terminal) of the transistor T is coupled to the data line DL1. The first terminal of the liquid crystal capacitor CLC is coupled to the first terminal of the transistor T, and the second terminal of the liquid crystal capacitor CLC is coupled to a common voltage VCOM.

It is worth mentioning that, for the convenience of explanation, in the display panel 110 of this embodiment, the display grayscale level of the pixel PX11 may, for example, be set to a grayscale value 0, the display grayscale level of the pixel PX12 may, for example, be set to a grayscale value 64, the display grayscale level of the pixel PX21 may, for example, be set to a grayscale value 128, and the display grayscale level of the pixel PX22 may, for example, be set to a grayscale value 255, in which the lower the grayscale value of a pixel, the darker the brightness displayed by the pixel, while the higher the grayscale value of a pixel, the brighter the brightness displayed by the pixel. Therefore, in this embodiment, the pixel PX11 may be used to represent a pixel displaying brightness in a dark state, while pixel PX22 may be used to represent a pixel displaying brightness in a bright state.

It should be noted that the display grayscale levels of each pixel shown in FIG. 1 may be determined according to the design requirements of the display panel 110, and the disclosure is not limited to the setting method. In this embodiment, the display panel 110 may be, for example, a cholesteric liquid crystal panel.

On the other hand, the scan driver 120 is coupled to the scan lines GL1, GL2 of the display panel 110. The scan driver 120 may provide scan signals GS1, GS2 to the display panel 110 respectively through the scan lines GL1, GL2 to perform scanning operations on the pixels PX11, PX12 and PX21, PX22 respectively.

The source driver 130 is coupled to the source lines DL1, DL2 of the display panel 110. The source driver 130 may provide source driver signals DATA1, DATA2 to the display panel 110 through the source lines DL1, DL2 respectively.

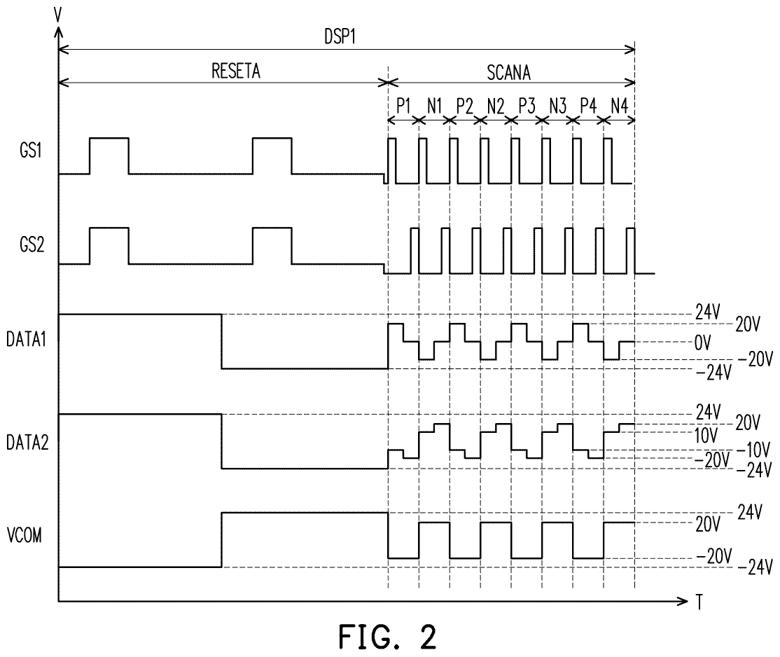

FIG. 2 is a timing diagram of the display device 100 in FIG. 1 according to the disclosure under a first driving method. Referring to FIG. 2, in the embodiment shown in FIG. 2, a display time interval DSP1 of the display device 100 may be divided into a reset period RESETA and a scan period SCANA. The display device 100 may operate sequentially in the reset period RESETA and the scan period SCANA, while the reset period RESETA and the scan period SCANA do not overlap with each other. In the embodiment, the scan period SCANA may include multiple positive polarity sub-periods P1 to P4 and multiple negative polarity sub-periods N1 to N4.

It should be noted that in the timing diagram of FIG. 2, the horizontal axis in FIG. 2 represents an operation time (T) of the display device 100, while the vertical axis in FIG. 2 represents voltage values (V) of the scan signals GS1, GS2, the source driver signals DATA1, DATA2, and the common voltage VCOM.

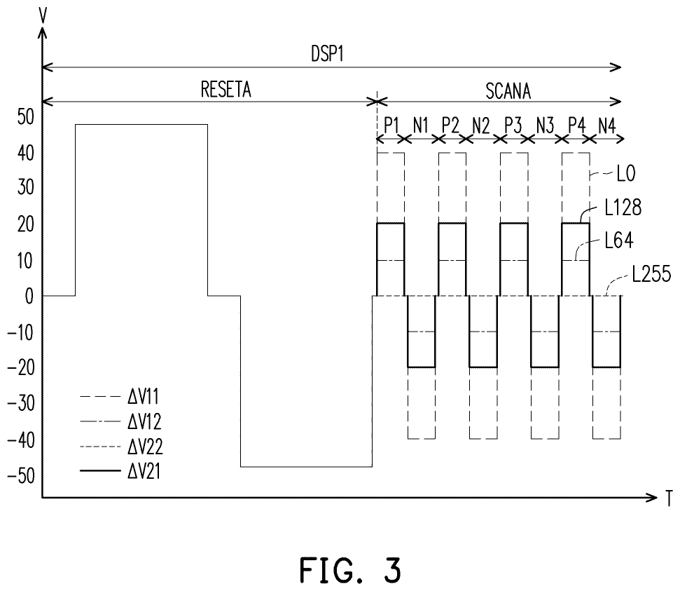

On the other hand, FIG. 3 is a waveform diagram of the pixel voltage difference of each pixel in the embodiment in FIG. 1 under the first driving method according to the disclosure. Referring to FIG. 3, in the waveform diagram shown in FIG. 3, waveforms L0, L64, L128, and L255 may respectively represent the variation states of pixel voltage differences of the pixel PX11 (that is, the grayscale value 0), the pixel PX12 (that is, the grayscale value 64), the pixel PX21 (that is, the grayscale value 128), and the pixel PX22 (that is, the grayscale value 255) of the display panel 110 during the display time interval DSP1. In the waveform diagram shown in FIG. 3, the waveforms L0, L64, L128, and L255 are illustrated with different types of line segments respectively.

For example, the waveform L0 may represent the voltage difference between the second terminal (for example, the drain terminal) of the pixel PX11 and the common voltage VCOM (that is, a pixel voltage difference ΔV11); the waveform L64 may represent the voltage difference between the second terminal (for example, the drain terminal) of the pixel PX12 and the common voltage VCOM (that is, a pixel voltage difference ΔV12); the waveform L128 may represent the voltage difference between the second terminal (for example, the drain terminal) of the pixel PX21 and the common voltage VCOM (that is, a pixel voltage difference ΔV21); the waveform L255 may represent the voltage difference between the second terminal (for example, the drain terminal) of the pixel PX22 and the common voltage VCOM (that is, a pixel voltage difference ΔV22).

It should be noted that in the waveform diagram of FIG. 3, the horizontal axis in FIG. 3 represents the operation time (T) of the display device 100, while the vertical axis in FIG. 3 represents voltage values (V) of the pixel voltage differences ΔV11, ΔV12, ΔV21, and ΔV22.

Regarding the implementation details of the display device 100 shown in FIG. 1 under the first driving method (for example, pulse amplitude modulation, PAM driving method), reference may be made to FIG. 1 to FIG. 3 simultaneously. In detail, when the display device 100 operates in the reset period RESETA of the display time interval DSP1, the scan driver 120 may generate enabled (for example, high voltage level) scan signals GS1, GS2 to the pixels PX11, PX12 and PX21, PX22 of the display panel 110. Additionally, the source driver 130 may, under a first polarity (that is, the positive polarity) of the reset period RESETA, correspondingly generate the source driver signals DATA1, DATA2 with voltage values of 24V to the second terminals of the pixels PX11, PX12, PX21, and PX22 according to the enabled scan signals GS1, GS2.

Additionally, during the first polarity of the reset period RESETA, the display device 100 may set the voltage value of the common voltage VCOM to −24V.

In this situation, as shown in FIG. 3, when the display device 100 operates in the first polarity of the reset period RESETA, the voltage values of the pixel voltage differences (that is, ΔV11, ΔV12, ΔV21, and ΔV22) of each pixel PX11, PX12, PX21, and PX22 in the display panel 110 are all adjusted to 48V.

Subsequently, as shown in FIG. 2, the source driver 130 may, under a second polarity (that is, the negative polarity) of the reset period RESETA, correspondingly generate the source driver signals DATA1, DATA2 with voltage values of −24V to the second terminals of the pixels PX11, PX12, PX21, and PX22 according to the enabled scan signals GS1, GS2.

Additionally, during the second polarity of the reset period RESETA, the display device 100 may set the voltage value of the common voltage VCOM to 24V.

In this situation, as shown in FIG. 3, when the display device 100 operates in the second polarity of the reset period RESETA, the voltage values of pixel voltage differences (that is, ΔV11, ΔV12, ΔV21, and ΔV22) of each pixel PX11, PX12, PX21, and PX22 in the display panel 110 are all adjusted to −48V.

In other words, when the display device 100 operates in the first polarity or the second polarity of the reset period RESETA, the source driver 130 may adjust the voltage magnitude of the source driver signals DATA1, DATA2 and the common voltage VCOM to reset the absolute values of the pixel voltage differences ΔV11, ΔV12, ΔV21, and ΔV22 of each pixel PX11, PX12, PX21, and PX22 to a maximum voltage difference value (that is, the voltage value of 48V). Under this setting condition, based on the cholesteric liquid crystal driving technology, the display device 100 may display images during the reset period RESETA with the liquid crystal in the pixels PX11, PX12, PX21, and PX22 arranged in the planar state.

On the other hand, after completing the related reset operations of the reset period RESETA, the display device 100 may subsequently execute the scan operation of the scan period SCANA of the display time interval DSP1. Specifically, when the display device 100 operates in the scan period SCANA of the display time interval DSP1, the scan driver 120 may generate sequentially enabled scan signals GS1, GS2 to the pixels PX11, PX12 and PX21, PX22 in the display panel 110 to scan the pixels PX11, PX12 and PX21, PX22.

Subsequently, during the scan period SCANA, the source driver 130 may set the voltage peak value of the source driver signal corresponding to the scanned pixel according to the display grayscale level (or grayscale value of the display grayscale) of at least one scanned pixel among the pixels PX11, PX12 and PX21, PX22.

For the convenience of explanation, the following will take embodiments using the pixels PX11 and PX22 as examples of scanned pixels for related explanations. Embodiments using the pixels PX12 and PX21 as examples of scanned pixels may be analogized accordingly.

Referring to FIG. 1 together with FIG. 3, for example, assuming that the display device 100 takes the pixel PX11 as the scanned pixel, during the positive polarity sub-period P1 of the scan period SCANA, the transistor T of the scanned pixel PX11 may be turned on according to the enabled scan signal GS1. Subsequently, the source driver 130 may set the voltage peak value of the corresponding source driver signal DATA1 to 20V according to the display grayscale level (that is, the grayscale value 0) of the scanned pixel PX11.

Additionally, during the positive polarity sub-period P1 of the scan period SCANA, the display device 100 may set the voltage value of the common voltage VCOM to −20V.

In this situation, as shown by the waveform L0 in FIG. 3, when the display device 100 operates in the positive polarity sub-period P1 of the scan period SCANA, the voltage value of the pixel voltage difference ΔV11 of the scanned pixel PX11 is adjusted to 40V (that is, the waveform L0).

Conversely, as shown in FIG. 2, during the negative polarity sub-period N1 of the scan period SCANA, the transistor T of the scanned pixel PX11 may be turned on according to the enabled scan signal GS1. Subsequently, the source driver 130 may set the voltage peak value of the corresponding source driver signal DATA1 to −20V according to the display grayscale level (that is, the grayscale value 0) of the scanned pixel PX11.

Additionally, during the negative polarity sub-period N1 of the scan period SCANA, the display device 100 may set the voltage value of the common voltage VCOM to 20V.

In this situation, as shown by the waveform L0 in FIG. 3, when the display device 100 operates in the negative polarity sub-period N1 of the scan period SCANA, the voltage value of the pixel voltage difference ΔV11 of the scanned pixel PX11 is adjusted to −40V (that is, the waveform L0).

On the other hand, assuming that the display device 100 takes the pixel PX22 as the scanned pixel, during the positive polarity sub-period P1 of the scan period SCANA, the transistor T of the scanned pixel PX22 may be turned on according to the enabled scan signal GS2. Subsequently, the source driver 130 may set the voltage peak value of the corresponding source driver signal DATA2 to −20V according to the display grayscale level (that is, the grayscale value 255) of the scanned pixel PX22.

Additionally, during the positive polarity sub-period P1 of the scan period SCANA, the display device 100 may set the voltage value of the common voltage VCOM to −20V.

In this situation, as shown by the waveform L255 in FIG. 3, when the display device 100 operates in the positive polarity sub-period P1 of the scan period SCANA, the voltage value of the pixel voltage difference ΔV22 of the scanned pixel PX22 is adjusted to 0V (that is, the waveform L255).

Conversely, as shown in FIG. 2, during the negative polarity sub-period N1 of the scan period SCANA, the transistor T of the scanned pixel PX22 may be turned on according to the enabled scan signal GS2. Subsequently, the source driver 130 may set the voltage peak value of the corresponding source driver signal DATA2 to 20V according to the display grayscale level (that is, the grayscale value 255) of the scanned pixel PX22.

Additionally, during the negative polarity sub-period N1 of the scan period SCANA, the display device 100 may set the voltage value of the common voltage VCOM to 20V.

In this situation, as shown by the waveform L255 in FIG. 3, when the display device 100 operates in the negative polarity sub-period N1 of the scan period SCANA, the voltage value of the pixel voltage difference ΔV22 of the scanned pixel PX22 is adjusted to 0V (that is, the waveform L255).

It should be noted that, regarding the implementation details of the scanned pixels PX11, PX22 operating in the positive polarity sub-periods P2 to P4 and the negative polarity sub-periods N2 to N4 of the scan period SCANA, reference may be made to the related descriptions of the scanned pixels PX11, PX22 operating in the positive polarity sub-period P1 and the negative polarity sub-period N1 of the scan period SCANA and may be analogized accordingly, so details will not be repeated here.

Additionally, regarding the variation states of the pixel voltage difference ΔV12 and the pixel voltage difference ΔV21 respectively corresponding to the pixel PX12 and the pixel PX21 during the scan period SCANA, reference may be made to the related descriptions of the pixel voltage difference ΔV11 and the pixel voltage difference ΔV22 respectively corresponding to the pixel PX11 and the pixel PX22 during the scan period SCANA and may be analogized accordingly, so details will not be repeated here.

In other words, in the embodiments in FIG. 1 to FIG. 3, when the display device 100 operates in the scan period SCANA, the display grayscale level (or grayscale value of the display grayscale) of the scanned pixel in the display panel 110 is negatively correlated with the voltage peak value of the corresponding source driver signal.

According to the above description, it may be understood that the source driver 130 of this embodiment may use the PAM driving method to set the voltage peak value of the corresponding source driver signal according to the display grayscale level of the scanned pixel. Thereby, the display grayscale of each pixel in the display panel 110 may be driven by the corresponding driving voltage.

In addition, in this embodiment, since the source driver 130 may apply the pixel voltage difference ΔV11 with a voltage value of 40V to the pixel PX11 during the scan period SCANA according to the display grayscale level of the pixel PX11 (that is, the grayscale value 0), the liquid crystal in the pixel PX11 may present a dark state of the display state as arranged in the homeotropic state according to the relatively large pixel voltage difference ΔV11.

As a result, compared to the related cholesteric liquid crystal display that presents a dark state of the display state in a focal conic state, the liquid crystal molecules of the pixels in the display device 100 of this embodiment may present the dark state of the display state as arranged in the homeotropic state. In this way, the display panel 110 is not affected by backscattering in the dark state display performance, thereby enhancing the contrast of the display panel 110 and improving the display quality of the display image.

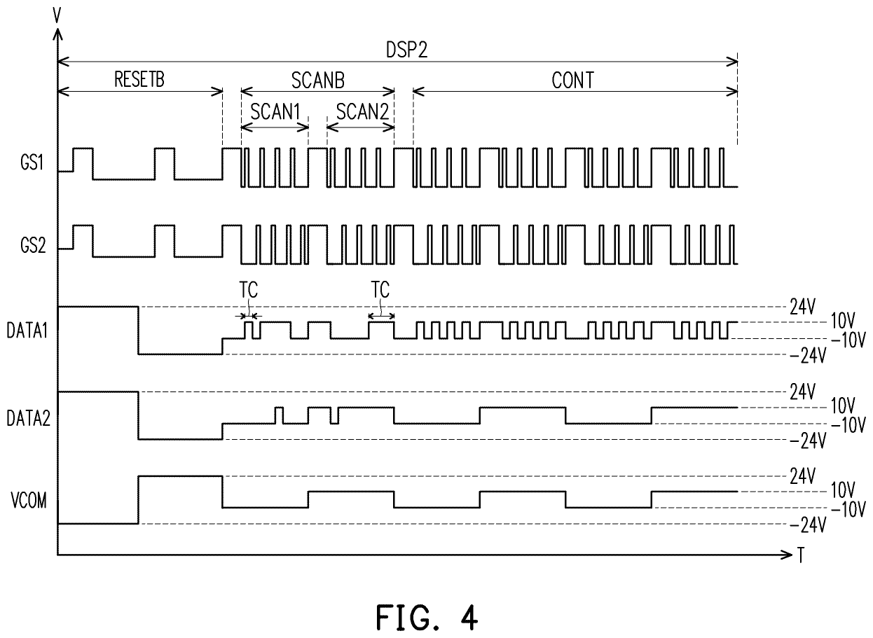

FIG. 4 is a timing diagram of the display device 100 in FIG. 1 according to the disclosure under a second driving method. Referring to FIG. 4, in the embodiment shown in FIG. 4, a display time interval DSP2 of the display device 100 may be divided into a reset period RESETB, a scan period SCANB, and a continuation period CONT. The display device 100 may operate sequentially in the reset period RESETB, the scan period SCANB, and the continuation period CONT, while the reset period RESETB, the scan period SCANB, and the continuation period CONT do not overlap with each other.

In the timing diagram shown in FIG. 4, the scan period SCANB may include multiple positive polarity sub-periods SCAN1 and multiple negative polarity sub-periods SCAN2. It should be noted that the horizontal axis in FIG. 4 represents the operation time (T) of the display device 100, while the vertical axis in FIG. 4 represents the voltage values (V) of the scan signals GS1, GS2, the source driver signals DATA1, DATA2, and the common voltage VCOM.

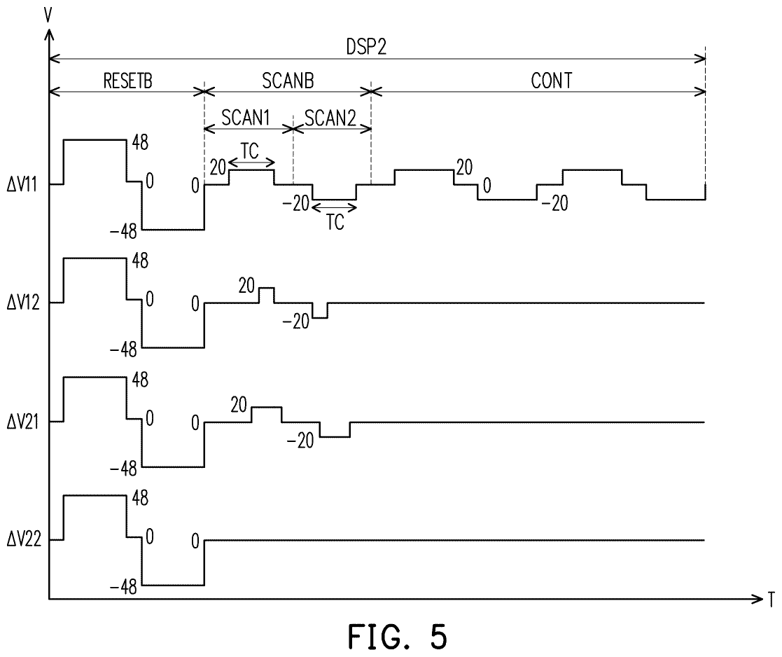

On the other hand, FIG. 5 is a waveform diagram of the pixel voltage difference of each pixel in the embodiment in FIG. 1 under the second driving method according to the disclosure. Referring to FIG. 5, the waveform diagram shown in FIG. 5 respectively represents the variation states of pixel voltage differences ΔV11, ΔV12, ΔV21, and ΔV22 of the pixels PX11, PX12, PX21, and PX22 of the display panel 110 during the display time interval DSP2.

It should be noted that the horizontal axis in FIG. 5 represents the operation time (T) of the display device 100, while the vertical axis in FIG. 5 represents the voltage values (V) of the pixel voltage difference ΔV11, the pixel voltage difference ΔV12, the pixel voltage difference ΔV21, and the pixel voltage difference ΔV22.

Regarding the implementation details of the display device 100 shown in FIG. 1 under the second driving method (for example, pulse-width modulation, PWM driving method), reference may be made to FIG. 1, FIG. 4, and FIG. 5 simultaneously. In the embodiment, for the implementation details of the display device 100 operating in the reset period RESETB of the display time interval DSP2, reference may be made to the related description of the display device 100 operating in the reset period RESETA of the display time interval DSP1 mentioned in FIG. 1 to FIG. 3 and may be analogized accordingly, so details will not be repeated here.

Subsequently, after completing the related reset operations of the reset period RESETB, the display device 100 may continue to execute the scan operations of the scan period SCANB of the display time interval DSP2.

It should be noted that, the present embodiment is unlike the embodiments in FIG. 1 to FIG. 3 where the source driver 130 uses the PAM driving method during the scan period SCANA to set the voltage peak value of the corresponding source driver signal according to the display grayscale level of the scanned pixel. In this embodiment, as shown in FIG. 4, the source driver 130 may provide the source driver signals DATA1, DATA2 with fixed voltage values (that is, 10V or −10V) to the pixels PX11, PX12, PX21, and PX22 during the scan period SCANB.

It should be noted that, in the embodiment in FIG. 4, the source driver 130 may set a duration TC of the corresponding source driver signals DATA1, DATA2 according to the display grayscale level (or grayscale value of the display grayscale) of at least one scanned pixel in the display panel 110, in which the duration TC may refer to the time during which the source driver signals DATA1, DATA2 maintain the fixed voltage value. And, as shown in FIG. 4, the time length of the duration TC is no longer than the time length of each positive polarity sub-period SCAN1 and each negative polarity sub-period SCAN2 in the scan period SCANB.

For the convenience of explanation, the following will take embodiments using the pixels PX11 and PX22 as examples of scanned pixels for related explanations. Embodiments using the pixels PX12 and PX21 s examples of scanned pixels may be analogized accordingly.

Referring to FIG. 1, FIG. 4, and FIG. 5 simultaneously, for example, assuming that the display device 100 takes the pixel PX11 as the scanned pixel, during the positive polarity sub-period SCAN1 or the negative polarity sub-period SCAN2 of the scan period SCANB, the transistor T of the scanned pixel PX11 may be turned on according to the enabled scan signal GS1. Subsequently, the source driver 130 may provide the source driver signal DATA1 with a fixed voltage value (that is, 10V or −10V) to the scanned pixel PX11 according to the enabled scan signal GS1.

In this situation, as shown in the waveform diagram of FIG. 5, when the display device 100 operates in the positive polarity sub-period SCAN1 or the negative polarity sub-period SCAN2 of the scan period SCANB, the voltage peak value of the pixel voltage difference ΔV11 of the scanned pixel PX11 may be adjusted to 20V or −20V.

In addition, in the embodiments in FIG. 4 and FIG. 5, during the scan period SCANB, the source driver 130 may set the time length of the duration TC of the corresponding source driver signal DATA1 according to the display grayscale level (that is, the grayscale value 0) of the scanned pixel PX11.

Furthermore, the source driver 130 may adjust the time length of the duration TC of the source driver signal DATA1 according to the display grayscale level (that is, the grayscale value 0) of the scanned pixel PX11, thereby allowing the time length of the duration TC during which the pixel voltage difference ΔV11 of the scanned pixel PX11 maintains at the voltage peak value (that is, 20V or −20V) to be extended.

On the other hand, assuming that the display device 100 takes the pixel PX22 as the scanned pixel, during the positive polarity sub-period SCAN1 or the negative polarity sub-period SCAN2 of the scan period SCANB, the transistor T of the scanned pixel PX22 may be turned on according to the enabled scan signal GS2. Subsequently, the source driver 130 may provide the source driver signal DATA2 with a fixed voltage value (that is, 10V or −10V) to the scanned pixel PX22 according to the enabled scan signal GS2.

In this situation, as shown in the waveform diagram of FIG. 5, when the display device 100 operates in the positive polarity sub-period SCAN1 or the negative polarity sub-period SCAN2 of the scan period SCANB, the voltage peak value of the pixel voltage difference ΔV22 of the scanned pixel PX22 may be adjusted to 0V.

In addition, in the embodiment in FIG. 4 and FIG. 5, during the scan period SCANB, the source driver 130 may set the time length of the duration TC of the corresponding source driver signal DATA2 according to the display grayscale level (that is, the grayscale value 255) of the scanned pixel PX22.

For example, the source driver 130 may adjust the time length of the duration TC of the source driver signal DATA2 according to the display grayscale level (that is, the grayscale value 255) of the scanned pixel PX22, thereby allowing the time length of the duration TC during which the pixel voltage difference ΔV22 of the scanned pixel PX22 maintains at the voltage peak value to be zero.

In other words, in the embodiments in FIG. 1, FIG. 4, and FIG. 5, when the display device 100 operates in the scan period SCANB, the display grayscale level (or grayscale value of the display grayscale) of the scanned pixel in the display panel 110 is negatively correlated with the duration of the corresponding source driver signal (or pixel voltage difference).

Therefore, in this embodiment, the source driver 130 of this embodiment may use the PWM driving method to adjust the duration of the corresponding source driver signal (or pixel voltage difference) according to the display grayscale level of the scanned pixel. Thereby, the display grayscale of each pixel in the display panel 110 may be driven by the corresponding driving voltage and duration.

On the other hand, after completing the related scanning operations of the scan period SCANB, the display device 100 may subsequently execute the operation actions of the continuation period CONT of the display time interval DSP2.

Specifically, in the embodiments in FIG. 4 and FIG. 5, when the display grayscale level (or grayscale value of the display grayscale) of the scanned pixel in the display panel 110 is lower than a preset grayscale threshold, the source driver 130 of this embodiment may continue to provide the source driver signal as pulse width modulation to the scanned pixel during the continuation period CONT.

In an embodiment, the grayscale threshold may be set according to the design requirements of the display panel 110. In this embodiment, when the display grayscale level of the scanned pixel is lower than the grayscale threshold, it is indicated that the scanned pixel may operate in a low grayscale state (for example, the dark state).

For example, as shown in FIG. 4, assuming that the display device 100 takes the pixel PX11 as the scanned pixel, based on the display grayscale level (that is, grayscale value 0) of the scanned pixel PX11 of the display panel 110 being lower than the grayscale threshold, the source driver 130 may, according to the display grayscale level of the scanned pixel PX11, continuously provide the pulse width modulated source driver signal DATA1 to the scanned pixel PX11 during the continuation period CONT.

In this situation, as shown in FIG. 5, during the continuation period CONT, the voltage state of the pixel voltage difference ΔV11 of the scanned pixel PX11 may continue the voltage state during the scan period SCANB, to maintain switching between 20V and −20V.

On the other hand, as shown in FIG. 4, assuming that the display device 100 takes pixel PX22 as the scanned pixel, based on the display grayscale level (that is, grayscale value 255) of the scanned pixel PX22 of the display panel 110 not being lower than the grayscale threshold, the source driver 130 may, according to the display grayscale level of the scanned pixel PX22, set the source driver signal DATA2 as a fixed reference voltage during the continuation period CONT.

In this situation, as shown in FIG. 5, during the continuation period CONT, the voltage state of the pixel voltage difference ΔV22 of the scanned pixel PX22 may continue the voltage state during the scan period SCANB, to maintain at 0V. That is, the source driver 130 may continuously apply the pixel voltage difference ΔV22 with a voltage value of 0V to the scanned pixel PX22 during the continuation period CONT.

Additionally, regarding the implementation details of the pixel PX12 and the pixel PX21 during the continuation period CONT, details may be analogized by referring to the related descriptions of the pixel PX22 during the continuation period CONT as mentioned in FIG. 4 to FIG. 5, and will not be repeated here.

That is to say, in this embodiment, during the continuation period CONT, the source driver 130 only continuously provides a relatively large pixel voltage difference to the scanned pixel with the display grayscale level lower than the preset grayscale threshold (that is, the pixel used to display dark state brightness), so that the pixel voltage difference of the scanned pixel may be continuously maintained at the voltage state of the scan period SCANB.

According to the above description, it may be understood that in this embodiment, the liquid crystal in the scanned pixels with display grayscale levels lower than the grayscale threshold (for example, the pixel PX11) may present a dark state of the display state as arranged in the homeotropic state according to the relatively large pixel voltage difference.

In this way, compared to the related cholesteric liquid crystal display that presents a dark state of the display state in a focal conic state, the liquid crystal molecules of the pixels in the display device 100 in this embodiment may present the dark state of the display state as arranged in the homeotropic state. In this way, the display panel 110 is not affected by backscattering in the dark state screen performance, thereby enhancing the contrast of the display panel 110 and improving the display quality of the display image.

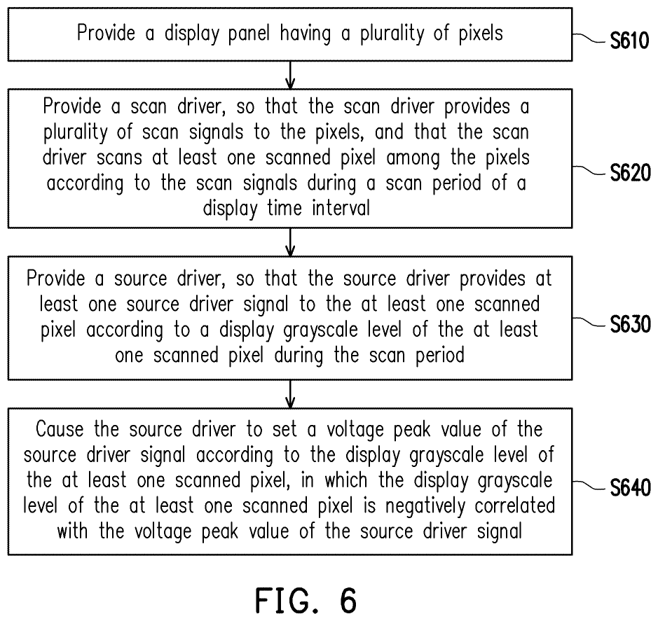

FIG. 6 is a flowchart of a driving method of the display device 100 according to an embodiment of the disclosure. Referring to FIG. 1 together with FIG. 6, in Step S610, the display device provides a display panel having a plurality of pixels. In Step S620, the display device provides a scan driver, so that the scan driver provides a plurality of scan signals to the plurality of pixels, and that the scan driver scans at least one scanned pixel among the plurality of pixels according to the plurality of scan signals during the scan period of the display time interval.

In Step S630, the display device provides a source driver, so that the source driver provides at least one source driver signal to the at least one scanned pixel according to the display grayscale level of the at least one scanned pixel during the scan period. In Step S640, the display device sets the voltage peak value of the source driver signal according to the display grayscale level of the at least one scanned pixel, in which the display grayscale level of the at least one scanned pixel is negatively correlated with the voltage peak value of the source driver signal.

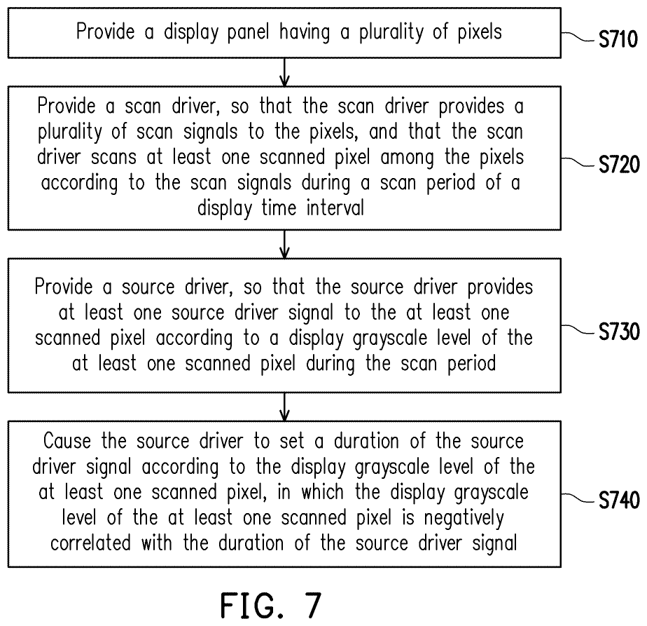

FIG. 7 is a flowchart of the driving method of the display device 100 according to another embodiment of the disclosure. Referring to FIG. 1 together with FIG. 7, in Step S710, the display device provides a display panel having a plurality of pixels. In Step S720, the display device provides a scan driver, so that the scan driver provides a plurality of scan signals to the plurality of pixels, and that the scan driver scans at least one scanned pixel among the plurality of pixels according to the plurality of scan signals during the scan period of the display time interval.

In Step S730, the display device provides a source driver, so that the source driver provides at least one source driver signal to the at least one scanned pixel according to the display grayscale level of the at least one scanned pixel during the scan period. In Step S740, the display device sets the duration of the source driver signal according to the display grayscale level of the at least one scanned pixel, in which the display grayscale level of the at least one scanned pixel is negatively correlated with the duration of the source driver signal.

Regarding the implementation details of the foregoing steps, there are thorough explanations in the foregoing embodiments and implementation methods, so details will not be repeated here.

In summary, the display device and the driving method thereof according to various embodiments of the disclosure may, through the source driver using PAM or PWM driving methods, enable the liquid crystal in the pixels of the display panel to present a dark state display state with a homeotropic state according to a relatively large pixel voltage difference. In this way, compared with the related cholesteric liquid crystal display device, the display device of the disclosure is not affected by backscattering in the dark state display performance, thereby enhancing the contrast of the display panel and improving the display quality of the display image.

What is claimed is:

1. A display device, comprising:
a display panel having a plurality of pixels;
a scan driver coupled to the display panel, and providing a plurality of scan signals to the pixels; and
a source driver coupled to the display panel, wherein
during a scan period of a display time interval, the scan driver scans at least one scanned pixel among the pixels according to the scan signals, and the source driver provides at least one source driver signal to the at least one scanned pixel according to a display grayscale level of the at least one scanned pixel, wherein
the source driver sets a voltage peak value of the source driver signal according to the display grayscale level of the at least one scanned pixel, and the display grayscale level of the at least one scanned pixel is negatively correlated with the voltage peak value of the source driver signal; or
the source driver sets a duration of the source driver signal according to the display grayscale level of the at least one scanned pixel, and the display grayscale level of the at least one scanned pixel is negatively correlated with the duration of the source driver signal.

2. The display device as claimed in claim 1, wherein the display time interval further comprises a reset period, and the source driver makes an absolute value of a voltage difference between two ends of each of the pixels to be a maximum voltage difference value in the reset period.

3. The display device as claimed in claim 2, wherein under a first polarity of the reset period, the voltage difference between the two ends of each of the pixels is a positive value, and under a second polarity of the reset period, the voltage difference between the two ends of each of the pixels is a negative value.

4. The display device as claimed in claim 1, wherein in the scan period, the source driver, corresponding to a first display grayscale, makes a first scanned pixel have a voltage difference of a first voltage, and the source driver, corresponding to a second display grayscale, makes a second scanned pixel have a voltage difference of a second voltage, wherein the first display grayscale is greater than the second display grayscale, and the first voltage is lower than the second voltage.

5. The display device as claimed in claim 4, wherein the scan period comprises a plurality of positive polarity sub-periods and a plurality of negative polarity sub-periods, during each of the positive polarity sub-periods, a voltage on a first end of the first scanned pixel is greater than a voltage on a second end of the first scanned pixel, and during each of the negative polarity sub-periods, the voltage on the second end of the first scanned pixel is greater than the voltage on the first end of the first scanned pixel.

6. The display device as claimed in claim 1, wherein the scan period comprises a plurality of positive polarity sub-periods and a plurality of negative polarity sub-periods, the source driver, corresponding to a first display grayscale, makes the source driver signal have the duration in each of the positive polarity sub-periods and the negative polarity sub-periods, a length of the duration is no longer than a time length of each of the positive polarity sub-periods and the negative polarity sub-periods.

7. The display device as claimed in claim 6, wherein in the duration, the source driver signal has a fixed voltage value.

8. The display device as claimed in claim 7, wherein the display time interval further comprises a continuation period, in response to the display grayscale level of the at least one scanned pixel being lower than a grayscale threshold, the source driver continues to provide the at least one source driver signal as pulse width modulation during the continuation period.

9. The display device as claimed in claim 8, wherein in response to the display grayscale level of the at least one scanned pixel not being lower than the grayscale threshold, the source driver sets the at least one source driver signal as a fixed reference voltage during the continuation period.

10. The display device as claimed in claim 1, wherein the display panel is a cholesteric liquid crystal panel.

11. A driving method of a display device, comprising:
providing a display panel having a plurality of pixels;
providing a scan driver, so that the scan driver provides a plurality of scan signals to the pixels, and that the scan driver scans at least one scanned pixel among the pixels according to the scan signals during a scan period of a display time interval;
providing a source driver, so that the source driver provides at least one source driver signal to the at least one scanned pixel according to a display grayscale level of the at least one scanned pixel during the scan period; and
causing the source driver to set a voltage peak value of the source driver signal according to the display grayscale level of the at least one scanned pixel, wherein the display grayscale level of the at least one scanned pixel is negatively correlated with the voltage peak value of the source driver signal; or
causing the source driver to set a duration of the source driver signal according to the display grayscale level of the at least one scanned pixel, wherein the display grayscale level of the at least one scanned pixel is negatively correlated with the duration of the source driver signal.

12. The driving method as claimed in claim 11, wherein the display time interval further comprises a reset period, and the driving method further comprises:
making, by the source driver, an absolute value of a voltage difference between two ends of each of the pixels to be a maximum voltage difference value in the reset period.

13. The driving method as claimed in claim 12, wherein under a first polarity of the reset period, the voltage difference between the two ends of each of the pixels is a positive value, and under a second polarity of the reset period, the voltage difference between the two ends of each of the pixels is a negative value.

14. The driving method as claimed in claim 11, further comprising:
making, by the source driver, in the scan period, corresponding to a first display grayscale, a first scanned pixel have a voltage difference of a first voltage; and
making, by the source driver, in the scan period, corresponding to a second display grayscale, a second scanned pixel have a voltage difference of a second voltage, wherein
the first display grayscale is greater than the second display grayscale, and the first voltage is lower than the second voltage.

15. The driving method as claimed in claim 14, wherein the scan period comprises a plurality of positive polarity sub-periods and a plurality of negative polarity sub-periods, and the driving method further comprises:
during each of the positive polarity sub-periods, making a voltage on a first end of the first scanned pixel greater than a voltage on a second end of the first scanned pixel; and
during each of the negative polarity sub-periods, making the voltage on the second end of the first scanned pixel greater than the voltage on the first end of the first scanned pixel.

16. The driving method as claimed in claim 11, wherein the scan period comprises a plurality of positive polarity sub-periods and a plurality of negative polarity sub-periods, and the driving method further comprises:
making, by the source driver, corresponding to a first display grayscale, the source driver signal have the duration in each of the positive polarity sub-periods and the negative polarity sub-periods, and a length of the duration is no longer than a time length of each of the positive polarity sub-periods and the negative polarity sub-periods.

17. The driving method as claimed in claim 16, wherein in the duration, making the source driver signal have a fixed voltage value.

18. The driving method as claimed in claim 17, wherein the display time interval further comprises a continuation period, in response to the display grayscale level of the at least one scanned pixel being lower than a grayscale threshold, making the source driver continue to provide the at least one source driver signal as pulse width modulation during the continuation period.

19. The driving method as claimed in claim 17, wherein in response to the display grayscale level of the at least one scanned pixel not being lower than the grayscale threshold, making the source driver to set the at least one source driver signal as a fixed reference voltage during the continuation period.

20. The driving method as claimed in claim 11, wherein the display panel is a cholesteric liquid crystal panel.
